(19) United States
(12) Patent Application Publication
(10) Pub. No.: US 2012/0209540 A1
(43) Pub. Date: Aug. 16, 2012

(54) Systems and Methods for Managing Wellhead Production

(76) Inventors: Neil Richardson, Salt Lake City, UT (US); William Richardson, Salt Lake City, UT (US); Michael Saltsman, Salt Lake City, UT (US); Anthony Brownlow, Salt Lake City, UT (US)

(21) Appl. No.: 13/028,172

(22) Filed: Feb. 15, 2011

(51) Int. Cl. G06F 19/00

(52) U.S. Cl. 702/45

(57) ABSTRACT

A system and method for monitoring and managing wellhead production and costs associated therewith. Electronic equipment is placed at the well head to monitor the volume of product lifted from at a wellhead. The equipment monitors both the volume and the percentage of products lifted and stored at the well head. The status of the separation and the volume can be monitored in real time or on a delayed time basis. The data is displayed on a map and used to identify efficient routes for gathering the lifted product at an appropriate time. The data may be displayed in a user interface which displays desired data in connection with each well head in a represented geographic region.

### BACKGROUND OF THE INVENTION

1. Field of the Invention

Systems and methods for monitoring reporting and managing wellhead production and waste are disclosed. In particular, systems and methods for tracking and mapping products produced from a wellhead whereby to coordinate sales, shipping, disposal, and transportation of desired materials and associated waste products are disclosed.

2. Background and Related Art

As demands for energy continue to grow, the need for reduction in costs associated with production of gas and oil also increases. Further, as the number of active wells increases, so do the complexities in efficiently monitoring and managing the large number of wells. Traditionally, a well log or borehole log was kept whereby to record all phases of a well's development, including drilling, completing, producing and abandoning. However, this method requires onsite analysis of the well which is inefficient and costly.

Thus, while techniques currently exist that are used to manage and record the activity of oil and gas wells, challenges still exist. Accordingly, it would be an improvement in the art to augment or even replace current techniques with other techniques.

### BRIEF SUMMARY OF THE INVENTION

Systems and methods for managing wellhead production are described. In particular, the disclosure relates to systems and methods for tracking and mapping products produced from a wellhead whereby to coordinate sales, shipping, disposal, and transportation of desired materials and associated waste products and to enable a greater efficiency of production.

In certain embodiments, a wellhead tracking and managing system is provided having a system of sensors that monitor the wellhead conditions generally and provide real or near real time data regarding the status of pumped or lifted product which may include water, gas, volatile organic compounds, oil, or other pumped products available for removal or disposal. In some implementations, a data transmitting device is provided whereby data obtained from the system of sensors is transmitted to a remotely located data processing unit. The data processing unit catalogs the data and provides reports in response to data inquiries. In some implementations, data processing unit further includes a computer readable program that coordinates reception and analysis of data from the system of sensors that monitor the wellhead conditions.

In some implementations, a wellhead tracking and managing system is provided further comprising flow control device, wherein the distribution of a product from the system is monitored and controlled by a flow control device. Accordingly, in some implementations flow data is retrieved by the flow control device and sent to the data processing unit via the data transmitting device. In other implementations, the flow control device is an integral part of the data transmitting unit. Data gathered from flow control device may be monitored or controlled in real-time or alternatively at a delayed time.

In some implementations, a wellhead tracking and managing system is provided further comprising an offload validation unit, wherein the distribution of a product from the system is recorded and validated by the data processing unit.

In some implementations, data stored within the data processing unit is sorted and provided to users in an online format. In some implementations, a user may customize the data to present the data in a desired format, and/or to remove any data that the user considers irrelevant to the user's inquiry. Further, in some implementations the stored data is used to increase the efficiency and decrease the costs associated with recovery and disposal of product lifted from the wellhead. In some implementations the data is interpreted remotely and then used to remotely control a variable production valve at the wellhead to optimize production levels.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows a schematic of a system for implementing exemplary embodiments in accordance with alternative representative embodiments.

FIG. 2 shows a networked system configuration that may be used in association with alternative embodiments in accordance with a representative embodiment.

FIG. 3 shows a perspective view of a wellhead managing system in accordance with alternative representative embodiments.

FIG. 4 shows a schematic view of a wellhead managing system in accordance with alternative representative embodiments.

FIG. 5 shows a flow chart of a process for managing data from a wellhead managing system in accordance with alternative representative embodiments.

FIG. 6 shows a schematic view of a wellhead managing system having a flow control unit in accordance with alternative representative embodiments.

FIG. 7 shows a flow chart of a process for managing data from a wellhead managing system in accordance with alternative representative embodiments.

FIG. 8 shows a schematic view of a wellhead managing system having an offload validation unit in accordance with alternative representative embodiments.

FIG. 9 shows a flow chart of a process for managing data from a wellhead managing system in accordance with alternative representative embodiments.

FIG. 10 shows a flow chart of various processes and methods for displaying stored data in accordance with alternative representative embodiments of the present invention.

FIG. 11 shows an online format display of stored data in accordance with alternative representative embodiments.

FIGS. 12-17 show various online format maps displaying various stored data in accordance with alternative embodiments of the present invention.

FIGS. 18-23 show various online format maps displaying various stored data in accordance with alternative embodiments of the present invention.

### DETAILED DESCRIPTION OF THE INVENTION

A description of alternative representative embodiments of the present invention will now be given with reference to the Figures. It is expected that the alternative representative embodiments may take many other forms and shapes, hence the following disclosure is intended to be illustrative and not limiting, and the scope of the invention should be determined by reference to the appended claims.

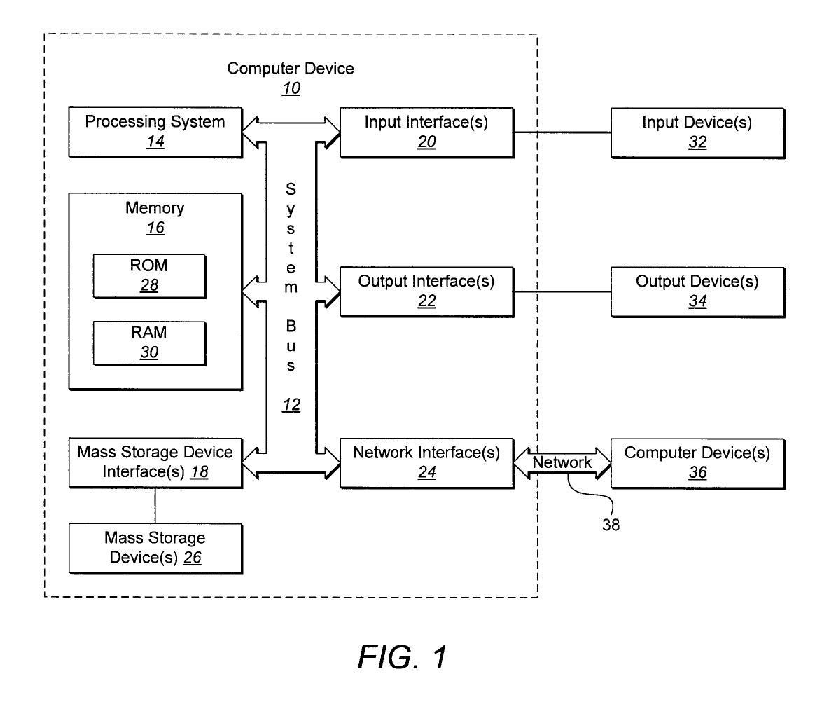

FIG. 1 and the corresponding discussion are intended to provide a general description of a suitable operating environment in which some embodiments may be implemented. One skilled in the art will appreciate that embodiments may be practiced by one or more computing devices and in a variety of system configurations, including in a networked configuration. However, while the methods and processes of the present invention have proven to be particularly useful in association with a system comprising a general purpose computer, embodiments include utilization of the methods and processes in a variety of environments, including embedded systems with general purpose processing units, digital/media signal processors (DSP/MSP), application specific integrated circuits (ASIC), stand alone electronic devices, and other such electronic environments.

Some alternative embodiments embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 1, a representative system for implementing embodiments of the invention includes computer device 10, which may be a general-purpose or special-purpose computer or any of a variety of consumer electronic devices. For example, computer device 10 may be a personal computer, a notebook computer, a netbook, a tablet, a personal digital assistant (“PDA”) or other hand-held device, a smart phone, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer-readable media, such as on memory 16, a magnetic hard disk, a removable magnetic disk, a magnetic cassette, an optical disk, or from a communication connection, which may also be viewed as a computer-readable medium.

Memory 16 includes one or more computer-readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer-readable medium. Mass storage devices 26 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), an integrated circuit, a firewire (IEEE 1394), or another interface. For example, in some embodiments input interface 20 includes an application specific integrated circuit (ASIC) that is designed for a particular application. In a further embodiment, the ASIC is embedded and connects existing circuit building blocks.

One or more output interfaces 22 may be employed to connect one or more corresponding output devices 34 to system bus 12. Examples of output devices include a monitor or display screen, a speaker, a printer, a multi-functional peripheral, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

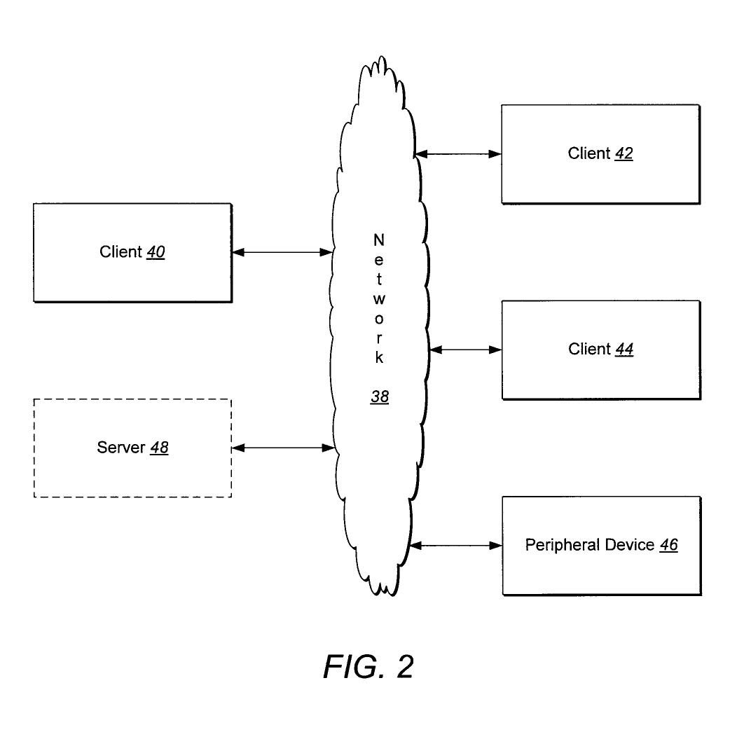

Thus, while those skilled in the art will appreciate that alternative embodiments may be practiced in a variety of different environments with many types of system configurations, FIG. 2 provides a representative networked system configuration that may be used in association with embodiments. The alternative representative system of FIG. 2 includes a computer device, illustrated as client 40, which is connected to one or more other computer devices (illustrated as client 42 and client 44) and one or more peripheral devices (illustrated as multifunctional peripheral (MFP) MFP 46) across network 38. While FIG. 2 illustrates an embodiment that includes a client 40, two additional clients, client 42 and client 44, one peripheral device, MFP 46, and optionally a server 48, which may be a print server, connected to network 38, alternative embodiments include more or fewer clients, more than one peripheral device, no peripheral devices, no server 48, and/or more than one server 48 connected to network 38. Other embodiments of the present invention include local, networked, or peer-to-peer environments where one or more computer devices may be connected to one or more local or remote peripheral devices. Moreover, alternative exemplary embodiments also embrace a single electronic consumer device, wireless networked environments, cellular or radio networked environments, satellite networked environments, and/or wide area networked environments, such as the Internet.

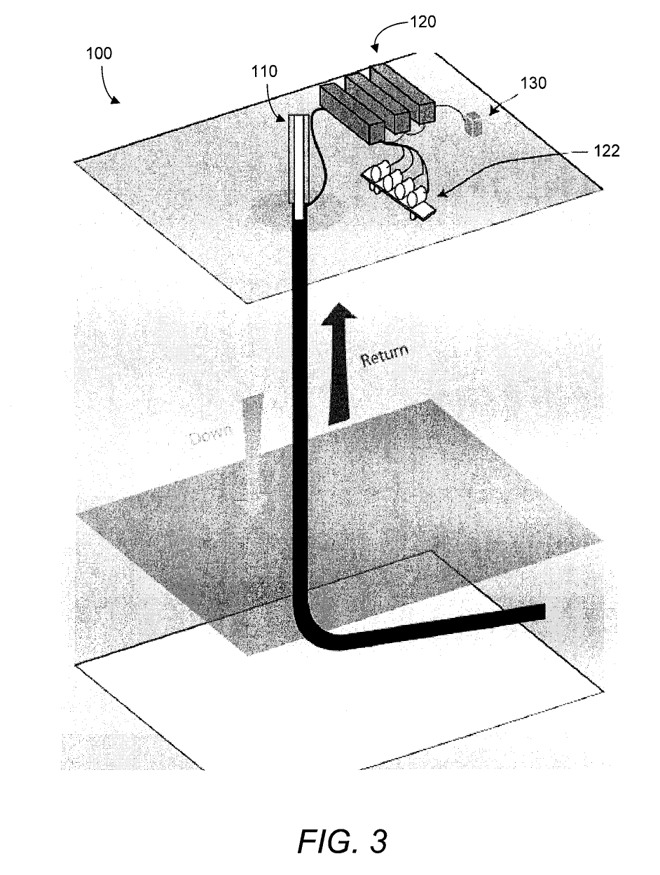

Some alternative exemplary embodiments are used to monitor and track inventories of equipment such as storage tanks or desired products and waste products produced at a producing well site, such as an oil well, a gas well, a mine, and the like. Referring now to FIG. 3, a non-limiting example of a producing well site 100, is shown. In some embodiments, well site 100 comprises an oil wellhead 110 which has been completed and thereby enabled to produce oil or gas. In some embodiments, a fluid storage tank (i.e. a frac tank) or a plurality of fluid storage tanks 120 are fluidly coupled to wellhead 110. Storage tanks 120 are commonly used for oil well fracturing methods whereby to increase production of a well. In some embodiments, chemicals 122 or a proppant are further added to storage tanks 120 as may be desired to facilitate various hydraulic fracturing methods.

A product lifted from wellhead 110 typically includes various desired products and waste products that are separated prior to final recovery. In some embodiments, a product lifted from the wellhead 110 is recovered and placed into storage tanks 120 wherein the various components of the lifted product undergo a process of separation. In some embodiments, this process of separation is monitored and reported via a wellhead managing system and device 130 which is operably coupled to storage tanks 120.

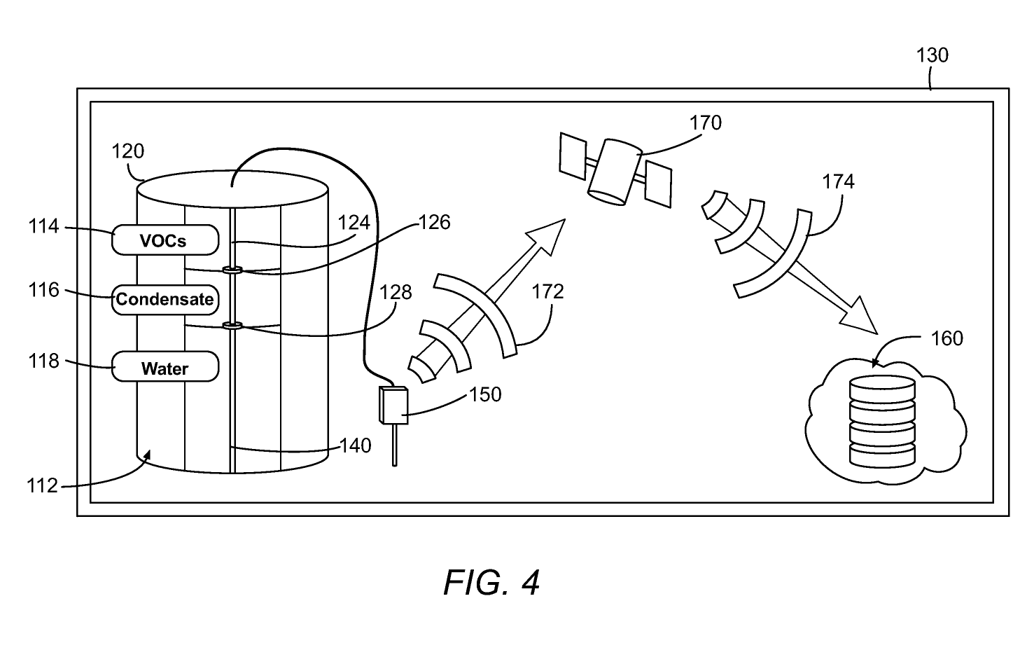

Referring now to FIG. 4, a non-limiting embodiment of a wellhead managing system and device 130 is shown. In some embodiments, wellhead managing system and device 130 comprises a storage tank 120 having a sensor system of variable density floats 124. In some embodiments, the variable density floats 124 are configured to translate along a rod 140 positioned within storage tank 120 to register the individual volumes of the various separated components within the lifted product 112. Thus, the relative percent compositions of the separated components within the lifted product 112 may be monitored based on the differing densities of the components.

For example, in some embodiments a lifted product 112 comprises a desired volatile organic compound component 114 having a first density, a desired hydrocarbon condensate component 116 having a second density, and an undesired waste water component 118 having a third density. Accordingly, in some embodiments the system of variable density floats 124 comprises a first float 126 having a density that is greater than component 114 and less dense that component 116. As such, float 126 registers within storage tank 120 at a point between adjacent components 114 and 116. Further, in some embodiments the system of variable density floats comprises a second float 128 having a density that is greater than component 116 and less dense than component 118. As such, float 128 registers at a point between adjacent components 116 and 118.

In some embodiments, the relative positions of the floats 126 and 128 determine completion of separation of components 114, 116 and 118 over time. For example, in some embodiments components 114, 116 and 118 undergo a period of separation within storage tank 120 prior to removal of said components from storage tank 120. Thus, in some embodiments the relative positions of floats 126 and 128 are monitored and recorded to determine the point in time at which separation of components 114, 116 and 118 is completed. In some embodiments, the period of separation is completed when the positions of floats 126 and 128 become stagnant. In other embodiments, the period of separation is completed when fluctuation of the floats' positions is limited to an acceptable amount of movement.

In some embodiments, the sensor system of variable density floats 124 is operably coupled to a data transmission device 150. Data transmission device 150 may include any technology or means whereby to transfer data from the system of variable density floats 124 to a remote data processing system 160. For example, in some embodiments data transmission device 150 receives and transfers data 172 from the system of variable density floats 124 to the remote data processing system 160 via existing fixed lines, temporary lines, satellite 170 and satellite transmission 174. In other embodiments, transmission device 150 utilizes at least one of microwave, fiber optic, internet protocol, cellular, radio, canobeam, terabeam, c-band, and ku-band transmission technologies to transfer data to the remote data processing system 160.

In some embodiment, data transmitting device 150 transmits data to data processing system 160 based on a timed interval such as pull technology where the data is requested from the data processing system 160. In other embodiments, data transmitting device 150 comprises push technology whereby any warnings or alerts at the wellhead are automatically sent to the remote data processing system 160 from data transmitting device 150 as they occur. Further, in some embodiments an open network socket connection is provided to directly and operably connect the wellhead 110 with the central server or data processing system 160 in real time. This open network socket connection provides a constant, open communication channel with each wellhead or wellhead device which permits data processing unit 160 to receive data immediately as detected by the sensor 124. The appropriate data transmitting protocol will be selected based on factors such as power management, signal strength, or connection availability. Thus, delays in reporting of warnings or alerts generated at the wellhead may be reduced or eliminated.

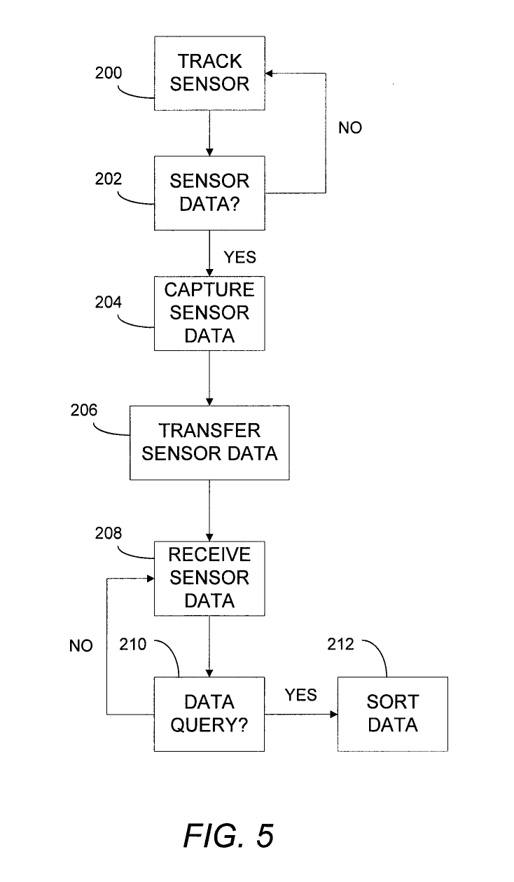

Some embodiments of the wellhead managing system and device 130 provide a data feedback system whereby the activity of a remotely located wellhead 110 is monitored in real time. In some embodiments, data processing system 160 comprises a computer readable program loaded onto a computer device configured to receive and analyze data sent from the data transmission device 150, as shown in FIG. 5.

Referring now to FIG. 5, in some embodiments the data transmission device 150 tracks 200 the sensor system of variable density floats 124 associated with the storage tank or tanks of a desired well site, wellhead, or group of well sites or wellheads. Upon detection of sensor data 202, data processing unit 160 captures the sensor data 204 and transfers the data 206 to the data processing unit 160. The data processing unit 160 receives and catalogs the sensor data 208 until a data query is made 210. In response to a data query, the data processing unit sorts and presents the requested data 212 to the requestor.

In some embodiments, the step of receiving the sensor data 208 further includes a process for identifying the desired wellhead, or well site, and establishing communication between the data processing system 160 and the data transmission device 150. The process for identifying the desired wellhead may include a step for selecting the wellhead from a list of accessible wellheads. For example, in some embodiments a database of traceable wellheads or wellhead managing systems 130 is provided, wherein each wellhead is assigned a unique identifier to enable directed access to the data of the desired wellhead. Alternative exemplary embodiments may display wellheads on an interaction map such as Google Earth®. The process of establishing communication may further include a step for accessing a secure server where the data from the data transmission device 150 has been encrypted or otherwise protected to prevent unauthorized access to and/or tampering with the sensor data.

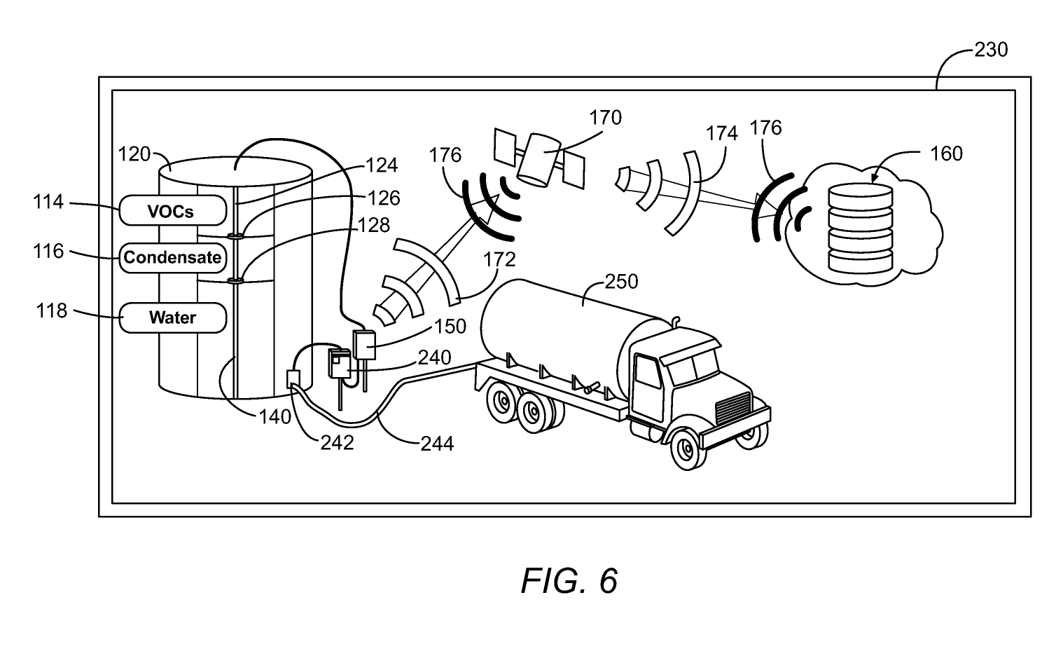

Referring now to FIG. 6, a non-limiting embodiment of a wellhead managing system and device 230 is shown. In some embodiments, wellhead managing system and device 230 further comprises a flow control device 240 whereby to control and manage removal of components 114, 116 and 118 from storage tank 120. For example, in some embodiments it is desirable to remove a waste product component 118 from storage tank 120 following separation of the various components of the lifted product 112. Some storage tanks 120 further include a valve 242 to accommodate coupling of a transfer hose 244 to the storage tank 120. The hose 244 is further coupled to a tanker truck 250 or another source for receiving the waste component from storage tank 120. For example, in some embodiments hose 244 is coupled to a pipeline, or is placed in an evaporation or sediment pond whereby to further process the waste product component 118.

In some embodiments, access to the lifted product 112 through valve 242 is controlled by flow control device 240. Further, in some embodiments flow control device 240 is controlled by data transmission device 150. For example, in some embodiments a tanker truck 250 is fluidly coupled to storage tank 120 via hose 244 and valve 242 for the purpose of removing waste product component 118 from storage tank 120. Flow control device 240 receives a signal from data transmission device 150 indicating the volume of component 118 within storage tank 120, based on the relative position of second float 128. Upon request, flow control device 240 opens valve 242 thereby causing waste product component 118 to be transferred to truck 250 via hose 244. Data transmission device 150 continues sending real time data to flow control device 240 indicating the decreasing volume of component 118 within storage tank 120. When the volume of component 118 reaches a set minimum value within storage tank 120 (as indicated by a registered position of second float 128 on rod 140), flow control device 242 receives this minimum value and closes valve 242, thereby preventing removal of desired components 116 and 114 from storage tank 120.

In other embodiments, flow control device 240 receives instructions indicating a specified volume of waste component 118 to be removed from storage tank 120 via valve 242. For example, if tanker truck 250 comprises an available volume that is less than the total volume of waste component 118 within storage tank 120, the available volume of tanker truck 250 is provided to flow control device 240 thereby preventing overfilling of tanker truck 250. In some embodiments, instructions are manually provided to flow control device 240 by direct entry via a key pad. In other embodiments, instructions are provided to flow control device 240 by scanning a barcode of an order provided to the flow control device 240 by the tanker truck 250. Further, in some embodiments, tanker truck 250 sends an electronic signal to the wellhead managing system and device 230, wherein the electronic signal contains instructions indicating a requested volume of waste component 118.

In some embodiments, flow control device 240 further comprises a flow density sensor which monitors the density of lifted product flowing through valve 242. When the flow density sensor detects a change in density of lifted product, valve 242 is closed thereby preventing an unintended component from being transferred to tanker truck 250. In some embodiments, flow control device 240 receives instruction from the flow density sensor to determine the time at which valve 242 is closed. In other embodiments, flow control device 240 receives and compares instructions from a flow density sensor, the sensor system of variable density floats 124, and the tanker truck 250 to determine the optimal volume of lifted product to transfer through valve 242. Accordingly, flow control device 240 accurately monitors and controls removal of lifted product from storage tank 120 via valve 242.

Following removal of waste component 118 from storage tank 120, additional lifted product 112 may be placed in storage tank 120 for further separation processing. As with the previous embodiments, first and second floats 126 and 128 continue to provide real time data concerning the relative volumes of desired and waste products within storage tank 120. Following further removal of waste component 118 from storage tank 120, desired product components 114 and 116 may be removed from storage tank 120 via valve 242 and flow control device 240, according to a similar procedure as previously explained for waste component 118.

In some embodiments, wellhead managing system and device 230 further comprise a feedback instruction 176 which is sent from the data processing device 160 to the flow control device 240 via existing fixed lines, temporary lines, microwave, fiber optic, internet protocol, cellular, radio, canobeam, terabeam, c-band, ku-band and/or satellite 170 transmission technologies. In some embodiments, feedback instruction 176 controls flow of lifted product 112 through valve 242. For example, in some embodiments data processing device 160 sends instructions 176 to flow control device 240 to open or close valve 242. In other embodiments, data processing device 160 sends instructions 176 to data transmitting device 150 and/or flow control device 240 to open or close variable valves associated with at least one of a wellhead 110, a storage tank 120, a tanker truck 250, or other device to regulate pressure and production levels for wellhead managing system and device 230.

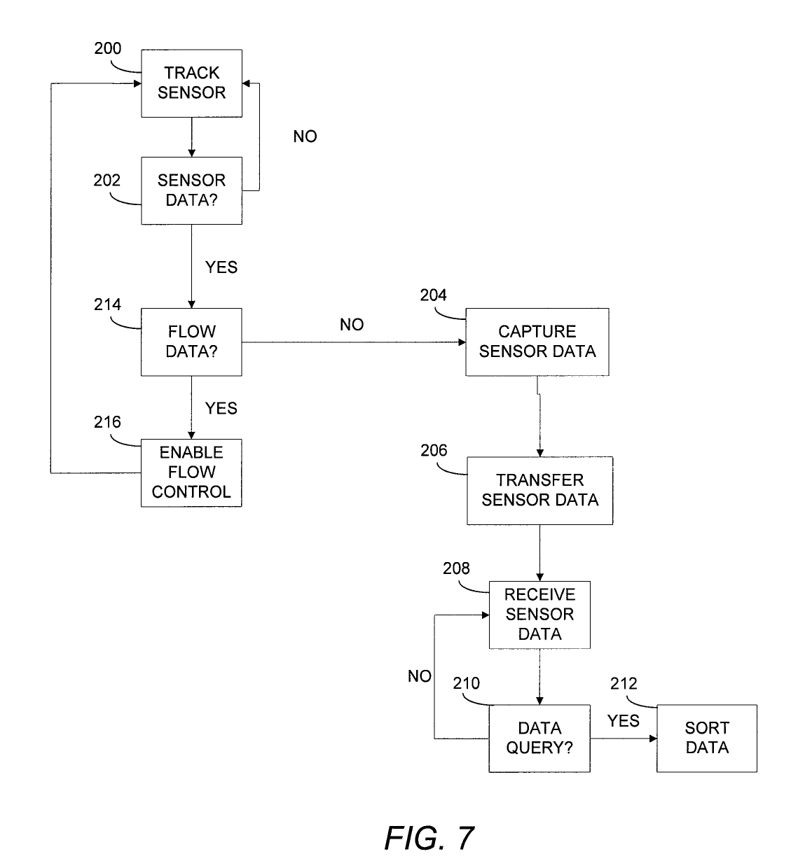

In some embodiments, data processing system 160 further comprises features for receiving and analyzing flow data sent from the data transmission device 150, as shown in FIG. 7.

Referring now to FIG. 7, in some embodiments data transmission device 150 tracks 200 the sensor system of variable density floats 124 associated with the storage tank or tanks of a desired well site, wellhead, or group of well sites or wellheads. Upon detecting removal or flow 214 of components from storage tank 120, flow control 216 is enabled thereby limiting the volume of product and type of product removed from storage tank 120. When the correct volume is achieved, flow ceases through valve 242 and final flow data 214 and sensor data 202 are captured by data transmission device 204 and transferred to data processing unit 160 preparatory to receiving a data query 210, as discussed previously.

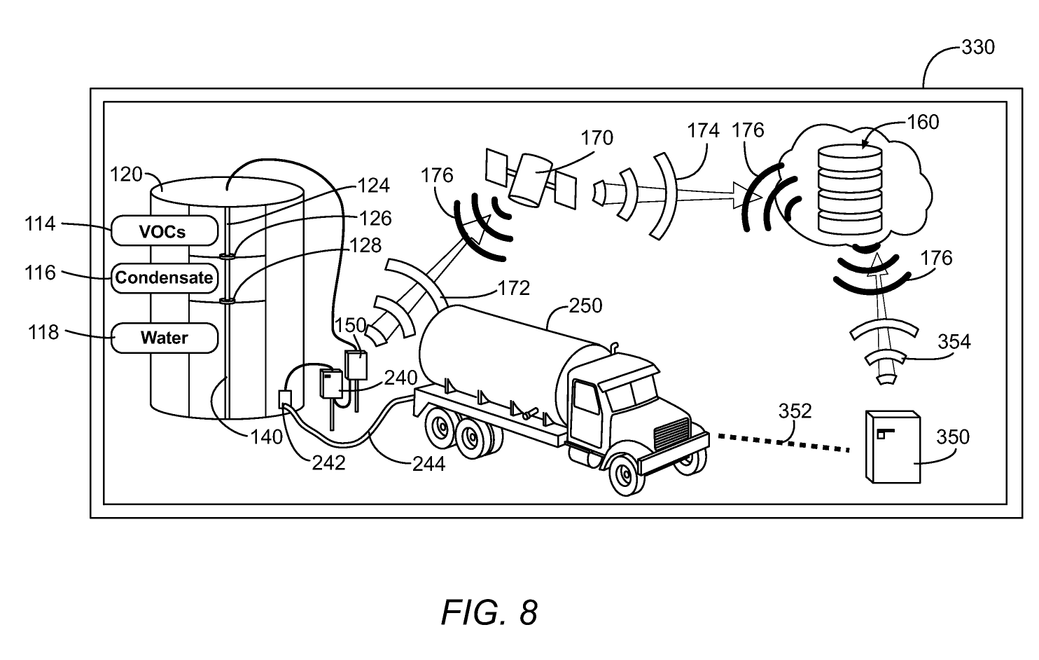

Referring now to FIG. 8, a non-limiting embodiment of a wellhead managing system and device 330 is shown. In some embodiments, wellhead managing system and device 330 further comprises an offload validation unit 350 whereby to validate the volume of product removed from storage tank 120 by tanker truck 250, or other means of removal as previously discussed. In some embodiments, offload validation unit 350 comprises a transceiver capable of receiving 352 information from tanker truck 250 and transferring or transmitting 354 that information to data processing unit 160. For example, in some embodiments it is desirable to confirm that the sensor system of variable density floats 124 is in proper working order. It would be difficult to access the interior of storage tanks 120 while storing lifted product 112. Accordingly, in some embodiments data processing unit 160 compares sensor data from data transmitting device 150 to offload data from offload validation unit 350 to determine if there is a discrepancy. If a discrepancy is detected, the data processing unit 160 flags the storage tank 120 and/or sensor system 124 for inspection and repair. In some embodiments, data processing unit 160 further transfers or transmit instructions 176 to offload validation unit 350 that are subsequently transferred to at least one of tanker truck 250, flow control device 240 and data transmitting device 150. In other embodiments, data processing unit 160 transfers or transmits instruction 176 to offload validation unit 350 for calibration purposes. For example, in some embodiments a further offload validation occurs when tanker truck 250 disposes the lifted product 112 received from storage tank 120. Information related to the additional offload validation is then communicated to offload validation unit 350 for calibration purposes. This information 354 may be further sent to the tanker truck 250, flow control device 240 and data transmitting device 150 for calibration or other purposes.

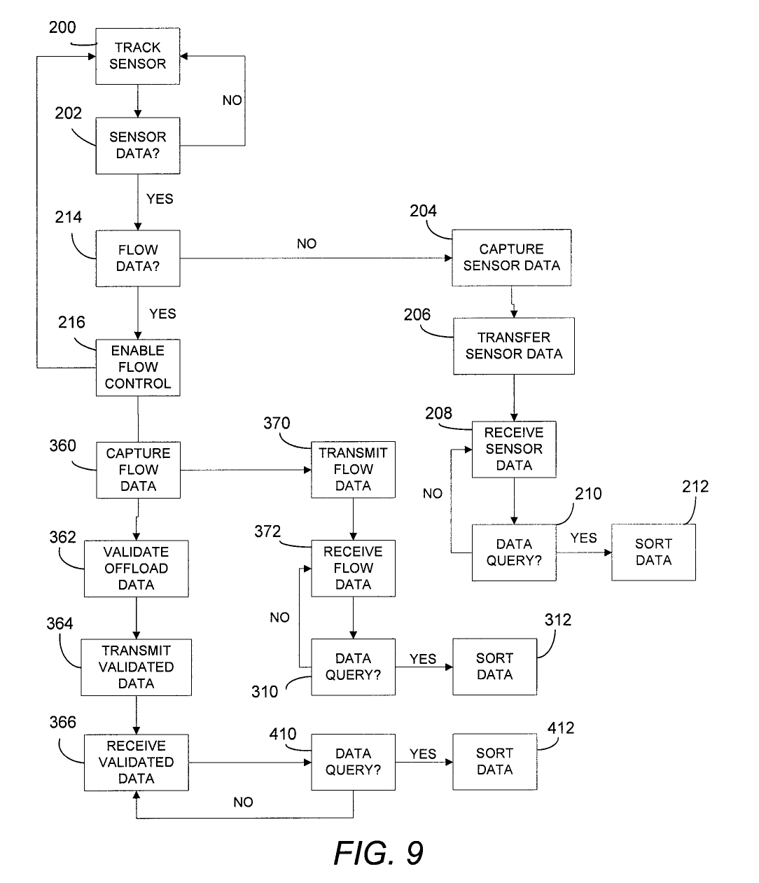

Referring now to FIG. 9, in some embodiments flow control device 240 further captures flow data 360 indicating the amount of product removed from the storage tank 120. The flow data is then transmitted 370 and received 372 by data processing unit 160. Upon performing a data query 310, data processing unit 160 sorts the data 312 and provides the requested information. In some embodiments, offload validation unit 350 validates offload data 362 of tanker truck 250. The validated data is then transmitted 364 and received 366 by data processing unit 160. Data processing unit 160 then compares the offload data to the flow data to determine if there is a discrepancy. If a discrepancy exists, data processing unit 160 creates a flag for storage tank 120 and/or sensor system 124 for inspection and repair. The data processing unit 160 further catalogs the validated data until a data query is made 410. In response to a data query, the data processing unit sorts and presents the requested data 412 to the requestor. In some embodiments, the validation data 362 is further used to track removal and disposal of desired and undesirable products from storage tank 120, thereby providing a record of all activity related to the well site 100.

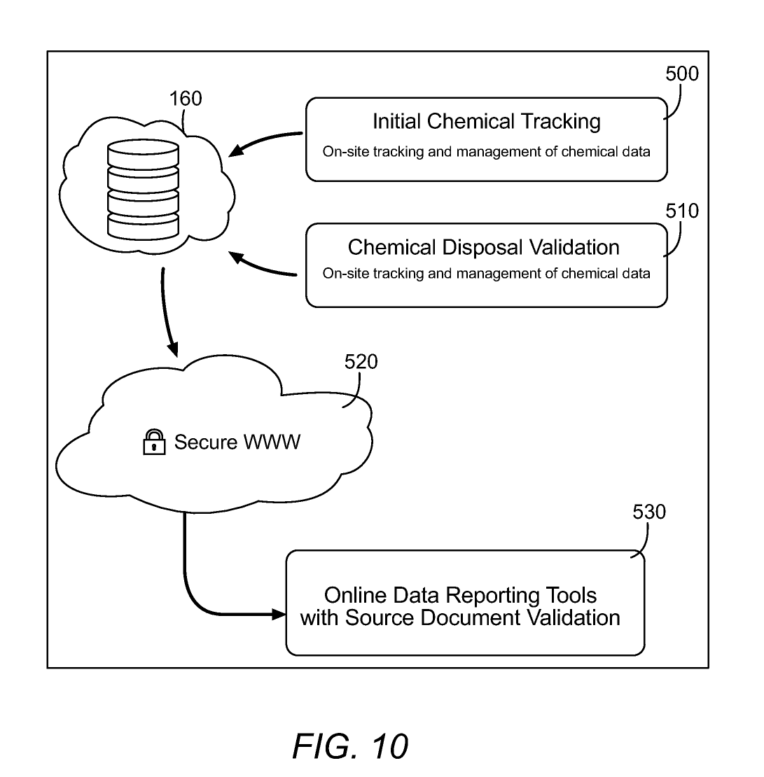

Referring now to FIG. 10, various applications of the present invention are shown. In some embodiments, various sources of data from the wellhead managing systems and devices of the present invention are stored and coordinated within the data processing unit 160 to facilitate initial tracking 500 of desired and undesired products from well site 100, as discussed above. Further, in some embodiments the data stored within data processing unit 160 is used to validate disposal 510 of the various components of the lifted product 112. In some embodiments, data stored within data processing unit 160 is provided in a secured online format 520 thereby enabling remote access 530 to, and processing of the stored data.

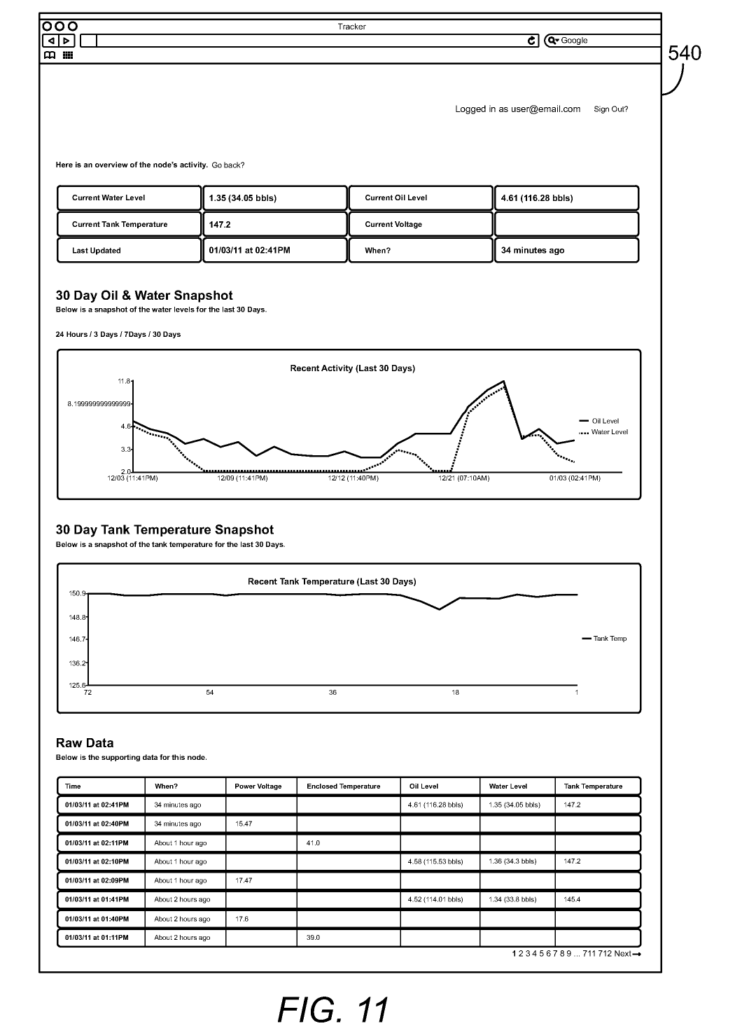

For example, referring now to FIG. 11, in some embodiments an online format of stored data is provided wherein a detailed report 540 displays queried data from the well site 100. In some embodiments, report 540 displays well-related information such as the temperature of the well, productivity history for the well, location of the well, alerts and warnings, as well as the raw data received from the various sensors of the well. In other embodiments, report 540 comprises a user customizable report, wherein a user may select the data and features provided in the report. Further, in other embodiments a user is provided with an option to download raw data associated with the well site 100, thereby enabling the user to implement the raw data into a preferred program or application as desired.

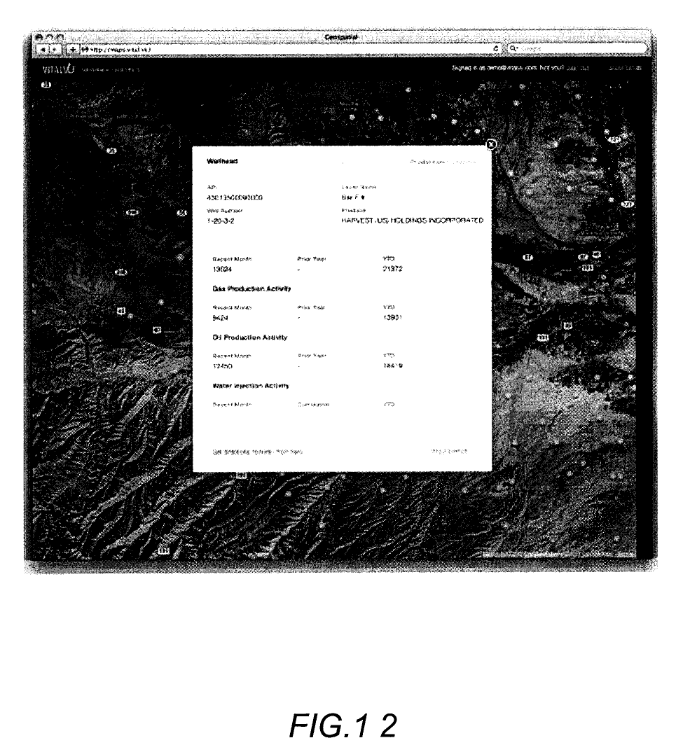

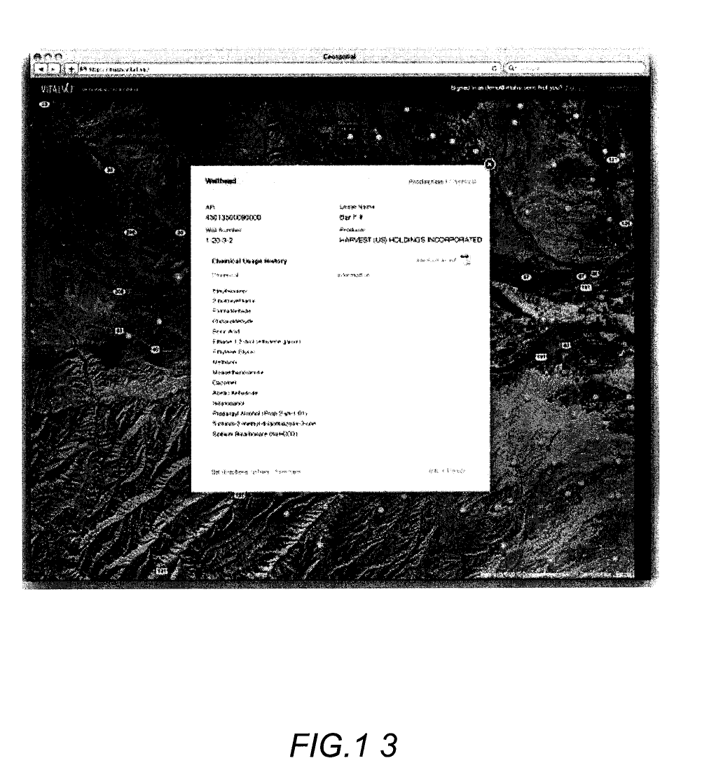

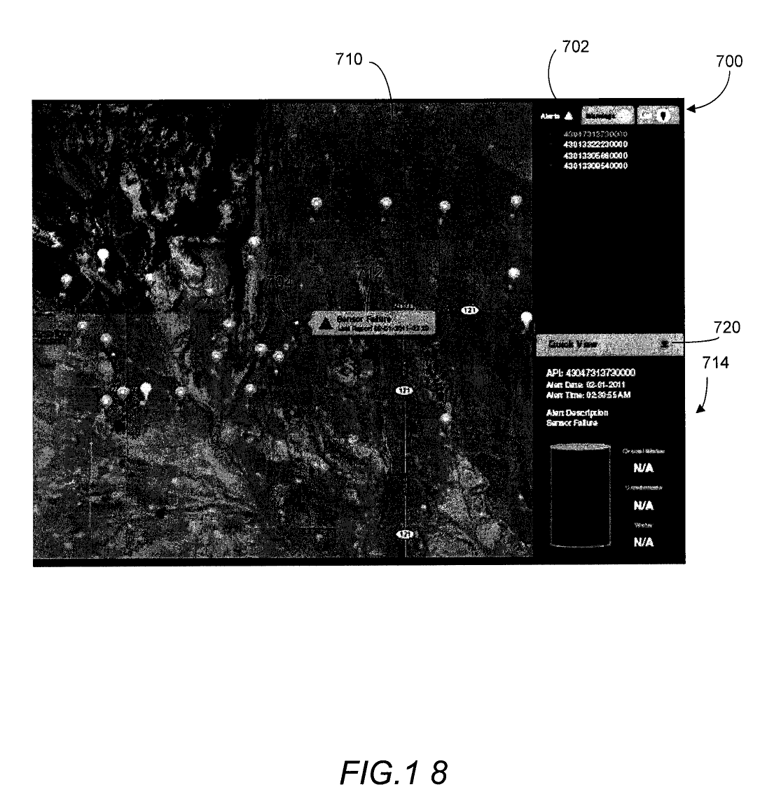

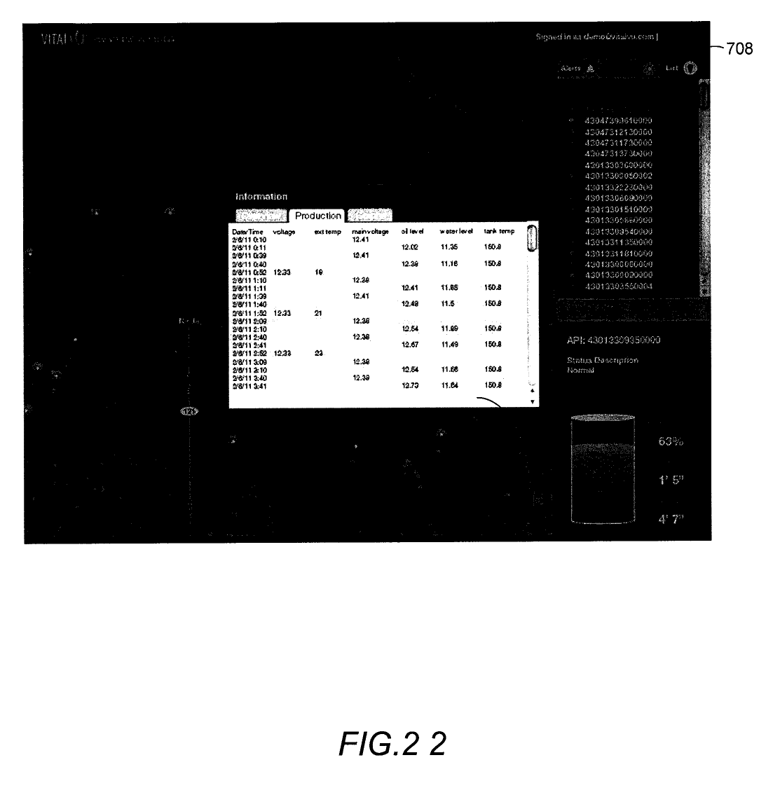

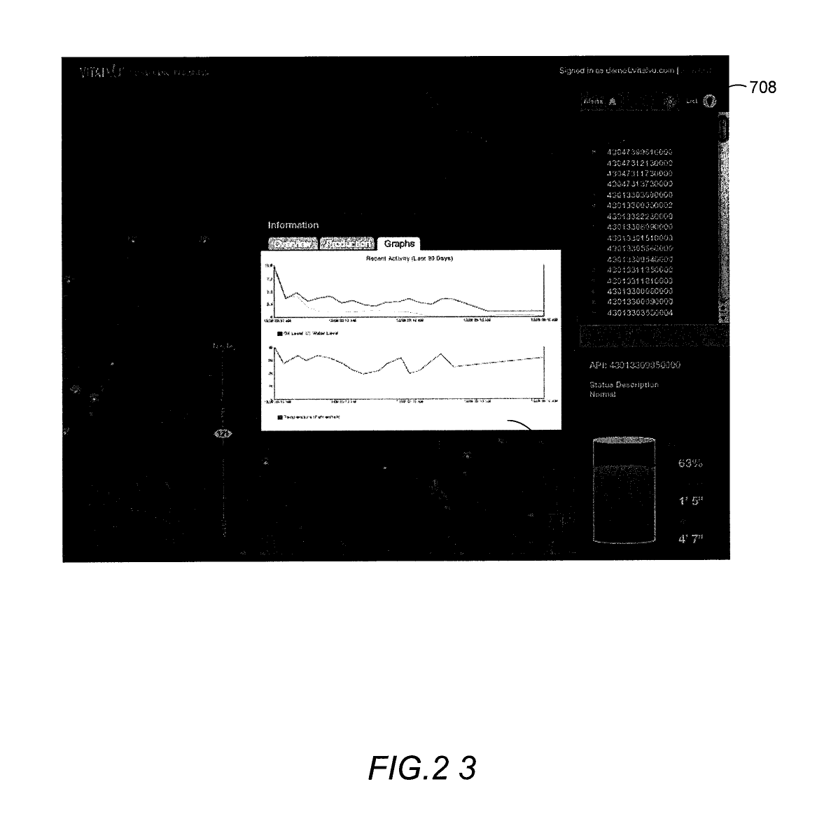

In other embodiments, data stored within the data processing unit is displayed to a user by selecting a well site 100 or wellhead 110 from a map, as shown in FIGS. 12-23. For example, in some embodiments a user is able to access information relating to wellhead productivity, such as gas production activity, oil production activity, and water injection activity, as shown in FIG. 12. In other embodiments, a use is able to access information relating to wellhead chemical usage history, as shown in FIG. 13.

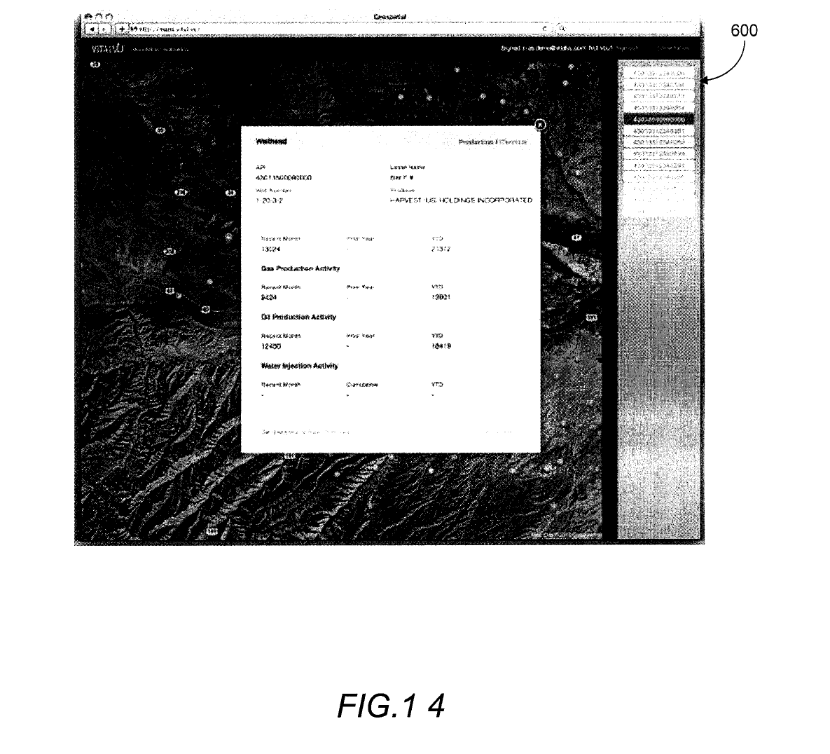

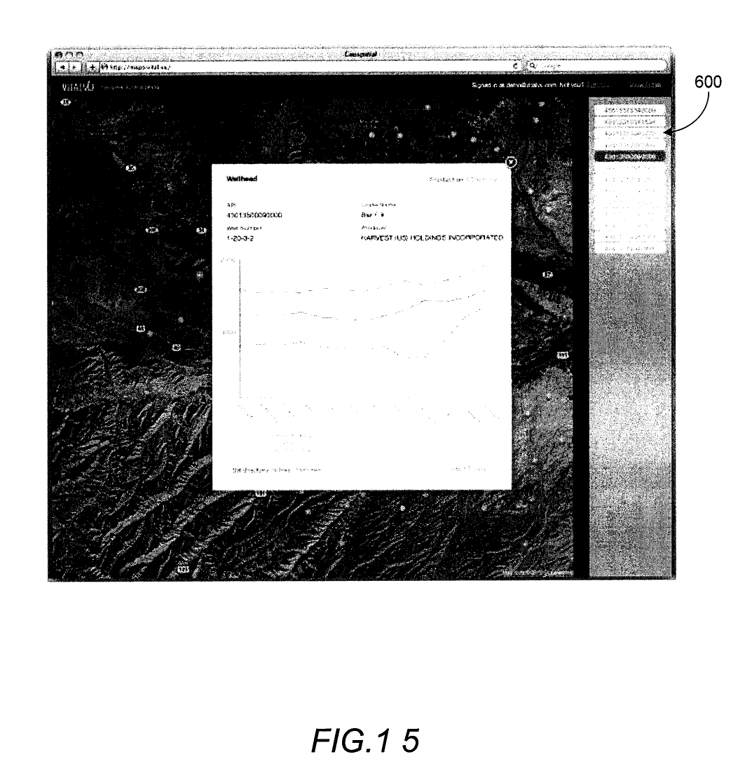

In some embodiments, a user is able to track a selected number of wellheads by creating a favorites list 600, as shown in FIG. 14. The user accesses various history details and statistics for the wellheads by selecting the predetermined wellheads from the favorites list 600. In some embodiments, favorites list 600 is automatically generated based on the viewing history of the user. Thus, as the user accesses and views data relating to a wellhead selected from a map, the wellhead is automatically saved to list 600 for future access. The user may then track the activity history of the wellhead or well site over time, as shown in FIG. 15.

In some embodiments, this information is used to plan trucking routes so as to maximize efficiency while minimizing costs. For example, in some embodiments an option is provided wherein a user may select various wellheads or well sites on a map based upon the proximity of the well sites and the amount of product available at the site. The system then provides the user with an optimized route and a projected overall cost based upon the cost of the product, cost of fuel, cost of production, cost of disposal, driver's cost, permits, as well as other variables that contribute to the overall cost analysis. Each variable cost is monitored and displayable to allow a user to manage the pick-up and distribution or disposal of product.

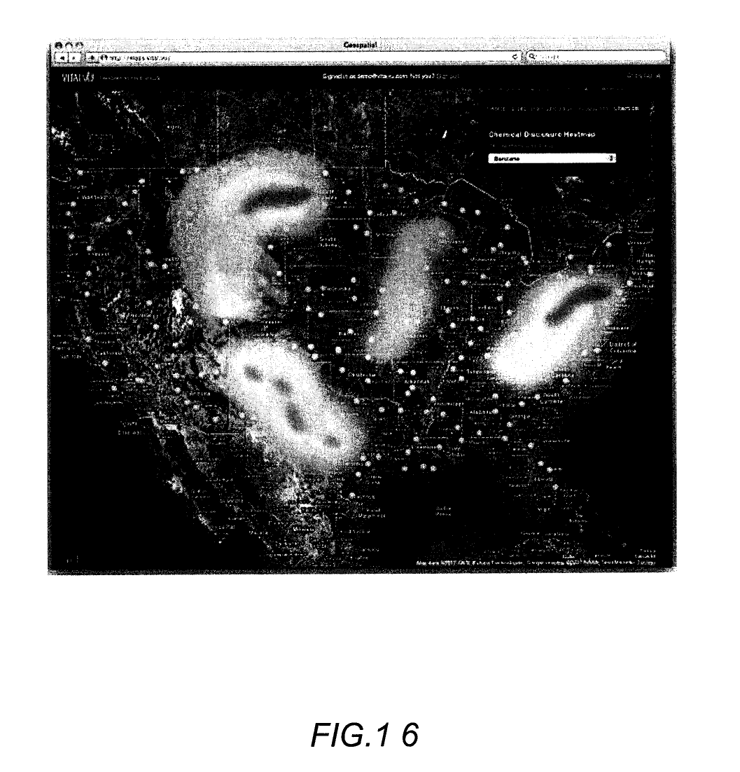

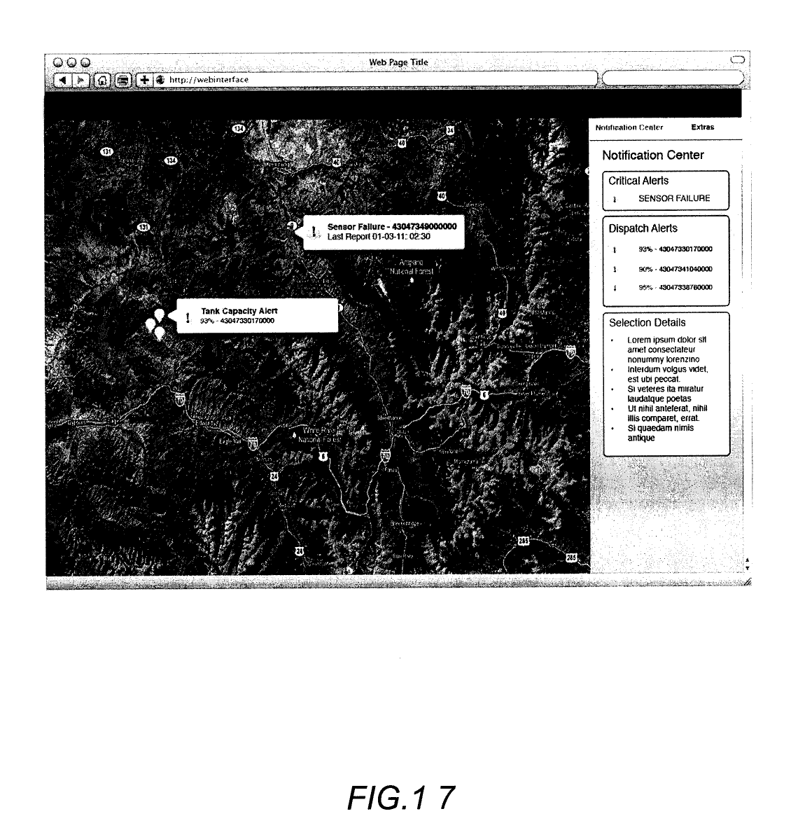

With reference to FIG. 16, in some embodiments stored data from the data processing unit 160 is used to display regional well productivity based on a set color gradation or other form of reference key. A visual reference key may also be used to provide a visual report to the user of chemical usage and/or production for regional well sites. Further, in other embodiments a user is able to access status alerts and notifications in a map format, as shown in FIG. 17. In some embodiments, a user selects a plurality of well sites in which there is an interest in receiving status alerts and notifications. In other embodiments, a user is apprised of a status alert or notification only after selecting to view the status of a well site. Further, in other embodiments a status alert or notification is automatically generated by date processing unit 160 upon detection of a status event. In some embodiments, a flag is generated and linked to the well site, wherein the flag contains information related to the well site and the status alert or notification.

In some embodiments, wellhead information is accessed by a user via a plurality of tabs 700. Tabs 700 may display preset categories of information, or may be set by a user to provide customized information, as desired. The tabs provide quick access to sorted data and information regarding the various wellheads within the current view of map 710. In some embodiments, the user accesses global information regarding alerts for the various wellheads by selecting the alerts tab 702. Upon selecting the alerts tab 702, wellhead identification numbers are displayed under the tab 702 for all wellheads that currently report an alert. In some embodiments, the user accesses specific information 712 regarding the alert by selecting the wellhead identification number shown. In other embodiments, specific information 712 regarding the alert is displayed on map 702 when the user hovers the pointer of the mouse over at least one of the wellhead identification number, or the wellhead marker 704 on the map 710. Further, upon selecting a wellhead identification number or marker 704, summary information 714 is displayed for the wellhead in a quick view window 720.

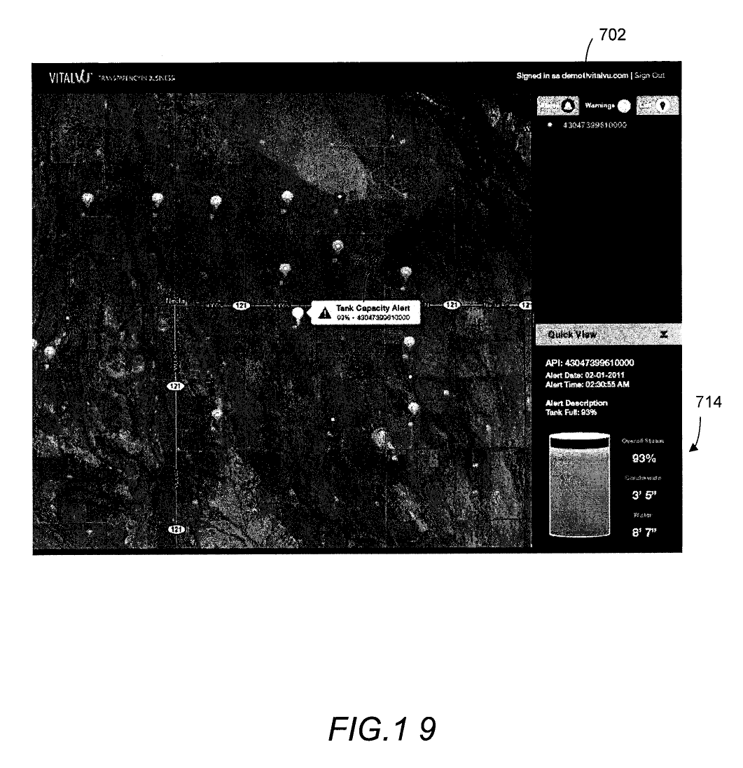

Information and/or statistics regarding warnings for a wellhead may be viewed by selecting the warning tab 706, as shown in FIG. 19. As with the previous example, specific information 712 is provided upon selecting a wellhead. For example, in some embodiments a warning is provided when the storage capacity of a wellhead is maximized. Summary information 714 is provided indicating percent capacity of the various components of the lifted product. Having been apprised of the wellhead's storage condition, the user may then schedule and dispatch a tanker truck to remove product from the storage tank.

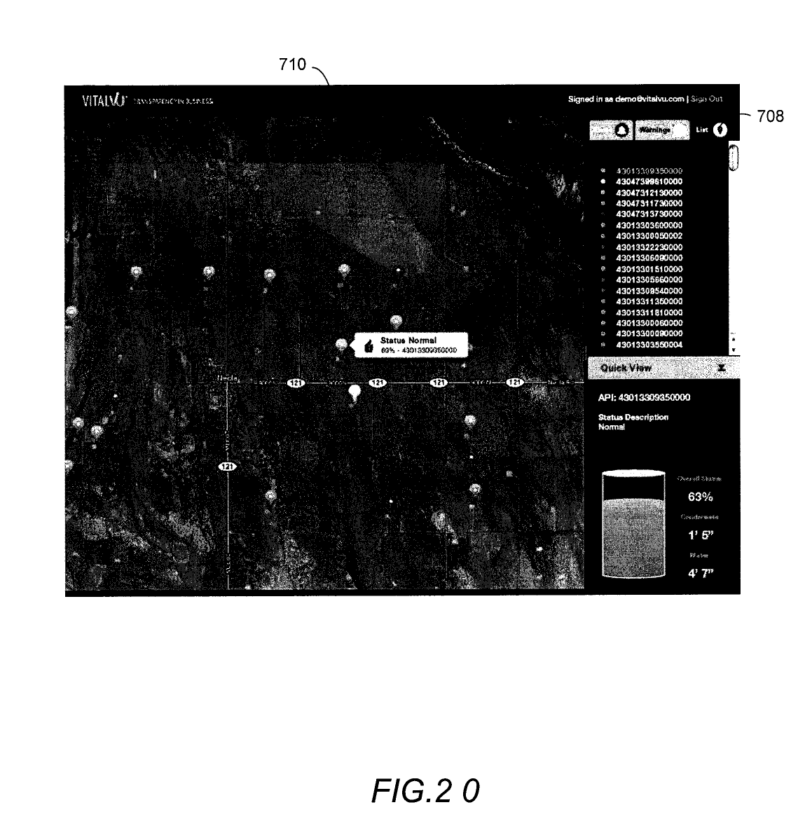

Information and/or statistics regarding other wellheads within the map view may be viewed by selecting a list tab 708, as shown in FIG. 20. In some embodiments, wellheads listed under list tab 708 include all wellheads within the viewable geographical area of map 710. In other embodiments, wellheads listed under list tab 708 comprise a group of wellheads selected by the user for quick reference and access, as described above.

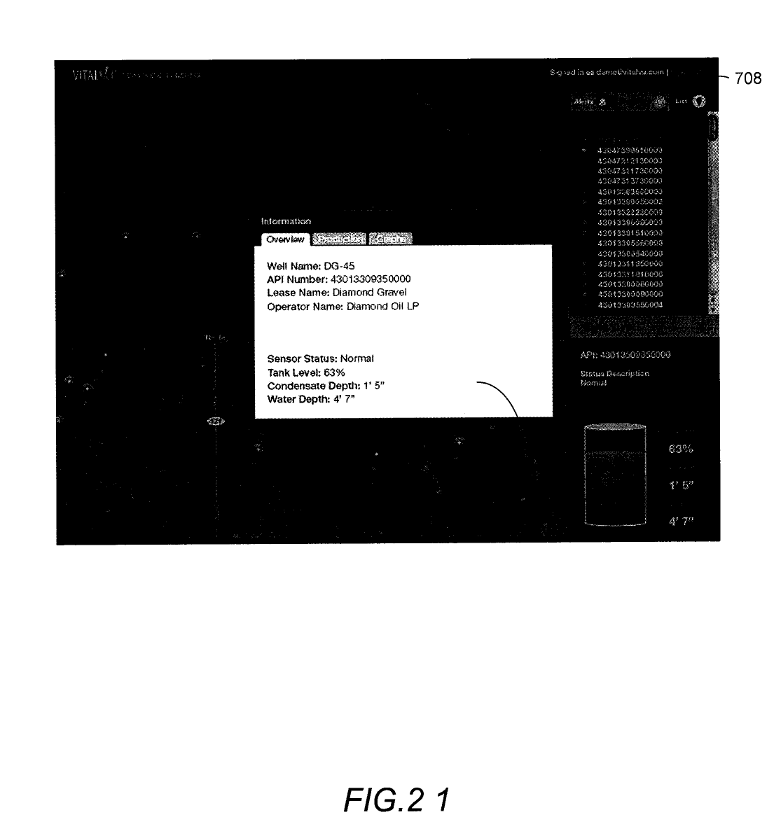

With reference to FIGS. 21-23, in some embodiments detailed information 716 is provided in an information window upon selecting a wellhead listed under list tab 708. In some embodiments, detailed information 716 comprises information and statistics relating to the overall condition and performance of the wellhead, production history, tank level, condensate depth, water depth, sensor status, well name, API number, lease name, operator name, and various graphical displays of desired information. In some embodiments, the information window comprises features whereby a user may customize the view and content of the window as may be required and/or desired by the user.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed is:

1. A computer readable medium product comprising computer readable instruction for implementing a method of managing chemical inventories, the computer readable medium product comprising executable code for implementing the steps for:
tracking a sensor operably coupled to a storage tank having a volume for receiving a product;
detecting data from the sensor;
capturing the data from the sensor;
transferring the data to a data processing system;
sorting the data; and
displaying at least a portion of the data on a map.

2. The method of claim 1, further comprising the steps of:
tracking a flow sensor operably coupled to the storage tank;
detecting flow data from the flow sensor;
capturing the flow data from the flow sensor;
transferring the flow data to the data processing system;
sorting the flow data; and
displaying at least a portion of the flow data on a map.

3. The method of claim 2, further comprising the steps of:
Manipulating a flow valve to enable or disable flow from the storage tank.

4. The method of claim 2, further comprising the steps of:
tracking an offload validation unit;
detecting offload data from the offload validation unit;
capturing offload data from the offload validation unit;
validating offload data;
transferring offload data to the data processing system;
sorting the offload data; and
displaying at least a portion of the offload data on a map.

5. The method of claim 1, wherein the product comprises a plurality of components.

6. The method of claim 1, wherein the sensor comprises a plurality of variable density floats.

7. The method of claim 6, wherein the product comprises a plurality of components, each component having a distinct density.

8. A system for managing chemical inventories, comprising:
a sensor operably coupled to a storage tank having a volume for receiving a product;
a remotely located data processing system operably coupled to the sensor for receiving and processing data from the sensor; and
a user accessible map displaying at least a portion of the data from the sensor.

9. The system of claim 8, wherein the product comprises a plurality of components, each component having a distinct density.

10. The system of claim 9, wherein the sensor comprises a plurality of variable density floats for detecting a volume of each component of the product within the storage tank.

11. The system of claim 8, wherein the user accessible map is a virtual map comprising a combination of geographical information and data from the sensor.

12. The system of claim 11, wherein the geographical information comprises a geographical location of the sensor.

13. The system of claim 8, further comprising a wellhead in fluid connection with the storage tank.

14. The system of claim 13, wherein the data from the sensor comprises at least one of an overall condition of the wellhead, a production history of the wellhead, a level of the storage tank, a condensate depth of the storage tank, a water depth of the storage tank, a sensor status, a well name, an API number, a lease name, and an operator name.

15. The system of claim 8, further comprising a data transmitting device operably coupled to the sensor, wherein the data transmitting device transmits the data from the sensor to the remotely located data processing unit.

16. The system of claim 8, further comprising;
a valve providing access to the product within the storage tank; and
a flow control device operably coupled to the valve for controlling outflow of the product from the storage tank.

17. The system of claim 16, further comprising an offload validation unit operably coupled to the remotely located data processing system for validating outflow of the product from the storage tank.

18. A method for managing chemical inventories, the method comprising:
tracking a sensor operably coupled to a storage tank having a volume of a product;
detecting data from the sensor;
transferring the data from the sensor to a data processing system;
generating a user accessible map containing the data from the sensor.

19. The method of claim 18, further comprising a wellhead operably coupled to the storage tank.

20. The method of claim 18, wherein the data from the sensor comprises at least one of an overall condition of the wellhead, a production history of the wellhead, a level of the storage tank, a condensate depth of the storage tank, a water depth of the storage tank, a sensor status, a well name, an API number, a lease name, and an operator name.
